(19) United States
(12) Patent Application Publication
(10) Pub. No.: US 2026/0369639 A1
(43) Pub. Date: Nov. 19, 2026

(54) FUEL CELL FAILURE DIAGNOSIS SYSTEM AND METHOD

(71) Applicants: Hyundai Motor Company, Seoul (KR); Kia Corporation, Seoul (KR)

(72) Inventors: Min Taek KIM, Hwaseong-si (KR); Jae Young SHIM, Hwaseong-si (KR); Won Jung KIM, Hwaseong-si (KR)

(21) Appl. No.: 19/640,026

(22) Filed: Apr. 6, 2026

(30) Foreign Application Priority Data
May 14, 2025 (KR) 10-2025-0062812

(51) Int. Cl. H01M 8/04664; B60L 3/00; H01M 8/04537

(52) U.S. Cl. CPC H01M 8/04679; B60L 3/0053; H01M 8/04589; H01M 2250/20

(57) ABSTRACT

A fuel cell failure diagnosis and/or management system may perform a fuel cell failure diagnosis and/or management method. The fuel cell failure diagnosis and/or management system includes sensors configured to obtain stack operation information, a memory configured to store data on diagnostic areas for fuel cell failure diagnosis, and a processor configured to perform control for fuel cell failure diagnosis using the stored diagnostic area data based on the obtained stack operation information. The diagnostic areas include a carbon monoxide poisoning diagnosis area set to diagnose carbon monoxide poisoning of a fuel cell electrode catalyst, and the processor diagnoses failure due to carbon monoxide poisoning, based on determining that a stack current and a stack voltage decrease and enter the carbon monoxide poisoning diagnosis area, during control of the stack current output during operation of the fuel cell stack to be set a predetermined diagnostic current.

### CROSS-REFERENCE TO RELATED APPLICATION

This application claims under 35 U.S.C. §119(a) the benefit of priority from Korean Patent Application No. 10-2025-0062812 filed on May 14, 2025, the entire contents of which are incorporated herein by reference.

### TECHNICAL FIELD

The present disclosure relates to a fuel cell failure diagnosis system and method. More specifically, it relates to a fuel cell failure diagnosis system and method capable of distinguishing and diagnosing poor purity of hydrogen, which is fuel gas supplied to a fuel cell stack during operation of a fuel cell vehicle, or carbon monoxide (CO) poisoning of a fuel cell electrode.

### BACKGROUND

Polymer electrolyte membrane fuel cells (PEMFCs), also known as proton exchange membrane fuel cells, feature high power density and are widely used as fuel cells for vehicles. Polymer electrolyte membrane fuel cells typically use hydrogen as fuel gas and oxygen (e.g., air including oxygen) as oxidizer gas.

A fuel cell stack includes fuel cells (cells herein) that generate electrical energy through a reaction between fuel gas and oxidizer gas. A fuel cell stack is usually provided in the form of a stack in which a plurality of cells are stacked in series to satisfy a required output level, for example.

In the case of fuel cell stacks mounted in vehicles, as high output (e.g., power, etc.) may be required, tens to hundreds of cells that individually generate electrical energy may be stacked and assembled in the form of a stack to meet the requirement.

The cell of the fuel cell stack may include a polymer electrolyte membrane capable of moving protons, a cathode and an anode. The cathode and the anode are electrode layers coated with catalysts that catalyze reactions of hydrogen and oxygen to react on both surfaces of the electrolyte membrane.

In the cell of the fuel cell stack, an assembly in which the cathode and the anode, which are catalyst electrodes, are stacked on both surfaces of the polymer electrolyte membrane is generally called a membrane electrode assembly (MEA).

The cell of the fuel cell stack may further include gas diffusion layers (GDLs) stacked on outer surfaces of the cathode and the anode. Separators stacked on the outer surfaces of the gas diffusion layers may supply fuel and discharge water through flow paths.

In a fuel cell vehicle, the fuel cell provides driving energy to drive the vehicle. Since chemical reactions occur during the operation of the fuel cell, the fuel cell must be managed so as to prevent deterioration, etc.

A cause of fuel cell failures may be poor purity of hydrogen (e.g., which is fuel gas). Hydrogen that fuels a fuel cell vehicle may contain impurities, such as nitrogen (N₂), helium (He), and/or carbon monoxide (CO). Impurities in hydrogen supplied to a fuel cell stack may cause stack performance deterioration during operation.

When the impurities are inert gas, such as nitrogen or helium, even if stack performance deteriorates, the performance of the stack may be preserved and/or restored through hydrogen purge. However, if carbon monoxide exists in hydrogen supplied to the fuel cell stack, a fuel cell electrode catalyst may be poisoned by the carbon monoxide.

That is, if carbon monoxide (CO) exists in hydrogen fuel for a fuel cell, CO may be adsorbed on a catalyst (e.g., platinum) on the anode of the fuel cell, which has a low potential, and thus, a catalyst active area may decrease (e.g., referred to herein as being “poisoned”) and seriously inhibit electrochemical reactions.

Technologies that diagnose failure in fuel cell stacks and perform a fail-safe function have been applied to fuel cell vehicles. Diagnostic technologies that may diagnose stack performance deterioration based on a stack voltage and/or a cell voltage ratio.

However, there are limitations in accurately distinguishing the causes of stack performance deterioration in fuel cell vehicles. In the case of failure due to poor hydrogen purity, it may not be possible to distinguish and/or diagnose the cause of the failure (type of impurity, etc.). Therefore, stack performance deterioration failure diagnosis technologies due to fueling with hydrogen having poor purity are not applied to fuel cell vehicles.

Quality control issues/limitations at hydrogen fueling stations, for example, may lead to fueling with hydrogen including CO, and this has led to an increase in vehicle failures. Without failure diagnosis and/or detection technologies and/or adequate diagnosis and/or detection technologies, drivers may continue to drive without recognizing failures. Most drivers recognize failures when/if the vehicles are no longer drivable, which poses a major threat to safety.

In a fuel cell vehicle, a decrease in the purity of hydrogen (e.g., fuel gas) may cause a decrease in the overall stack performance caused by CO poisoning and a decrease in some cell voltages due to inflow of impurities. Maintenance must be performed according to correct maintenance guidelines depending on a problem that has occurred.

Technologies that diagnose hydrogen purity deterioration based on the decrease in a cell voltage ratio due to inflow of impurities are limited to specifically distinguish CO poisoning. As a result, the possibility of misdiagnosis or incorrect maintenance increases because an exact cause of failure may not be identified.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses/devices, and methods are described for a fuel cell diagnosis and/or fuel cell management. In accordance with an aspect of the present disclosure, a fuel cell system is provided. The fuel cell system includes one or more sensors configured to obtain stack operation information indicating an operating state of a fuel cell stack. The fuel cell system includes a memory configured to store data indicating one or more diagnostic areas for fuel cell failure diagnosis, wherein the one or more diagnostic areas comprise a carbon monoxide poisoning diagnosis area associated with carbon monoxide poisoning of a fuel cell electrode catalyst. The fuel cell system includes a processor circuit configured to control, based on the stored data indicating the one or more diagnostic areas, a stack current output during operation of the fuel cell stack to be set to a diagnostic current. The processor circuit is configured to determine, based on the stack operation information obtained by the one or more sensors and based on the controlling the stack current output to be set to the diagnostic current, a stack current and a stack voltage. The processor circuit is configured to diagnose, based on the stack current and the stack voltage entering the carbon monoxide poisoning diagnosis area, failure associated with carbon monoxide poisoning of the fuel cell stack. The processor circuit is configured to control, based on the diagnosis of the failure, one or more operations associated with the fuel cell stack.

In accordance with other aspects of the present disclosure, the fuel cell system may include one or more of the following features. The one or more diagnostic areas may comprise a first diagnostic area defined by a set current range and a set voltage range, and the carbon monoxide poisoning diagnosis area may be set to have a lower current range than the set current range of the first diagnostic area. The stored data indicating the one or more diagnostic areas may comprise stack current values of the fuel cell stack and stack voltage values of the fuel cell stack. The processor circuit may be configured to determine, based on stack operation information obtained while operation of the fuel cell stack is set to use a current within the first diagnostic area before hydrogen fueling, whether stack performance of the fuel cell stack is normal before the hydrogen fueling. The processor circuit may be configured to control the stack current to be set to the diagnostic current further based on determining that the stack performance is normal before the hydrogen fueling. The processor circuit may be configured to determine, based on stack operation information obtained while operation of the fuel cell stack is set to use the current within the first diagnostic area, a minimum stack voltage value and a cell voltage ratio. The processor circuit may be configured to determine whether the stack performance is normal before the hydrogen fueling based on the minimum stack voltage value and the cell voltage ratio.

In accordance with other aspects of the present disclosure, the processor circuit may be configured to determine, based on the stack operation information obtained while operation of the fuel cell stack is set to use the current within the first diagnostic area after the hydrogen fueling, whether the stack performance is normal after the hydrogen fueling. The processor circuit may be configured to control, based on determining that the stack performance is abnormal after the hydrogen fueling, an emergency operation comprising an emergency purge operation for the fuel cell stack. The processor circuit may be configured to determine, based on stack operation information obtained while operation of the fuel cell stack is set to use the current within the first diagnostic area and after the emergency purge operation, whether the stack performance is normal before the hydrogen fueling. The processor circuit may be configured to control, based on the stack performance being determined as abnormal after the emergency operation, a diagnosis operation to diagnose a failure due to carbon monoxide poisoning of the fuel cell stack.

In accordance with other aspects of the present disclosure, the processor circuit may be configured to determine, based on stack operation information obtained while operation of the fuel cell stack is set to use a current within the first diagnostic area after hydrogen fueling, a minimum stack voltage value. The processor circuit may be configured to determine, based on the minimum stack voltage value being lower than or equal to a performance determination reference value, that stack performance of the fuel cell stack is abnormal after the hydrogen fueling. The performance determination reference value may be set to a value corresponding to the stack current from stack operation information obtained based on determining the minimum stack voltage value after the hydrogen fueling. The emergency purge operation may comprise an increased number of hydrogen purges for the fuel cell stack relative to a number of hydrogen purges during normal operation of the fuel cell stack. The processor circuit may be further configured to control, during the emergency operation, an increase in a hydrogen supply pressure for the fuel cell stack relative to a hydrogen supply pressure during normal operation of the fuel cell stack. The processor circuit may be configured to diagnose failure due to poor hydrogen purity caused by inflow of inert gas into supplied hydrogen.

In accordance with other aspects of the present disclosure, the processor circuit may be configured to accumulate the stack current until stack operation information indicates the stack current and stack voltage enter the carbon monoxide poisoning diagnosis area from the first diagnostic area. The processor circuit may be configured to determine, based on the accumulated stack current and during control of the stack current to be set to the diagnostic current, a carbon monoxide poisoning amount. The diagnostic current may be set to a current value within the first diagnostic area. The processor circuit may be configured to accumulate the stack current until the stack operation information indicates that, after the stack voltage decreases to a lower voltage limit within the first diagnostic area, the stack current decreases to a set current within the carbon monoxide poisoning diagnosis area. The processor circuit may be configured to, during control of the stack current output during the operation of the fuel cell stack to be set to use the diagnostic current, increase an upper battery charge limit to a set value higher than a value of the upper battery charge limit during normal operation of the fuel cell stack. The processor circuit may be configured to diagnose the failure occurred due to carbon monoxide poisoning based on the stack current and the stack voltage decrease remaining in the carbon monoxide poisoning diagnosis area for a set time or longer.

In accordance with another aspect of the present disclosure, a method is provided. The method includes receiving, by a processor associated with a fuel cell system from one or more sensors associated with the fuel cell system, stack operation information indicating an operating state of a fuel cell stack of the fuel cell system. The method includes controlling, by the processor, a stack current output during operation of the fuel cell stack to be set to a diagnostic current. The method includes determining, by the processor based on the stack operation information and based on the controlling the stack current output to be set to the diagnostic current, a stack current and a stack voltage. The method includes diagnosing, by the processor and based on the stack current and the stack voltage entering a carbon monoxide poisoning diagnosis area defined by stack current values and stack voltage values associated with carbon monoxide poisoning of a fuel cell electrode catalyst, failure of the fuel cell stack due to carbon monoxide poisoning. The method includes controlling, based on the diagnosis of the failure, one or more operations associated with the fuel cell stack.

In accordance with other aspects of the present disclosure, the method may include one or more of the following features. The carbon monoxide poisoning diagnosis area may be one of a plurality of diagnostic areas. The plurality of diagnostic areas may comprise a first diagnostic area defined by a set current range and a set voltage range, and the carbon monoxide poisoning diagnosis area may be set to have a lower current range than the set current range of the first diagnostic area. The method may further comprise determining, based on stack operation information obtained while operation of the fuel cell stack is set to use a current within the first diagnostic area before hydrogen fueling, whether stack performance of the fuel cell stack is normal before the hydrogen fueling. The method may further comprise controlling the stack current to be set to the diagnostic current further based on determining that the stack performance is normal before the hydrogen fueling.

In accordance with other aspects of the present disclosure, the method may further comprise determining, based on stack operation information obtained while operation of the fuel cell stack is set to use the current within the first diagnostic area after the hydrogen fueling, whether the stack performance is normal after the hydrogen fueling. The method may further comprise controlling, based on determining that the stack performance is abnormal after the hydrogen fueling, for emergency operation comprising an emergency purge operation for the fuel cell stack. The method may further comprise determining, based on stack operation information obtained while operation of the fuel cell stack is set to a current within the first diagnostic area and after the emergency purge operation, whether the stack performance is normal before the hydrogen fueling. The method may further comprise controlling, based on the stack performance being determined as abnormal after the emergency purge operation, a diagnosis operation to diagnose a failure associated with carbon monoxide poisoning of the fuel cell stack. The emergency purge operation may comprise an increased number of hydrogen purges for the fuel cell stack relative to a number of hydrogen purges during normal operation of the fuel cell stack. The method may further comprise controlling, during the emergency operation, an increase in a hydrogen supply pressure for the fuel cell stack relative to a hydrogen supply pressure during normal operation of the fuel cell stack.

In accordance with other aspects of the present disclosure, the method may further comprise accumulating the stack current until stack operation information indicates that the stack current and stack voltage enter the carbon monoxide poisoning area via the first diagnostic area. The method may further comprise determining, based on the accumulated stack current and during controlling of the stack current to be set to the diagnostic current, a carbon monoxide poisoning amount. The method may further comprise, during controlling of the stack current to be set to use the diagnostic current, increasing an upper battery charge limit to a value higher than a value of the upper battery charge limit during normal operation of the fuel cell stack.

In accordance with another aspect of the present disclosure, a vehicle is provided. The vehicle includes a fuel cell stack configured to supply power to the vehicle. The vehicle includes one or more sensors configured to obtain stack operation information indicating an operating state of the fuel cell stack. The vehicle includes a memory configured to store data indicating one or more diagnostic areas for fuel cell failure diagnosis, wherein the one or more diagnostic areas comprise a failure diagnosis area associated with a fuel cell electrode catalyst. The vehicle includes a processor circuit configured to control, based on the stored data indicating the one or more diagnostic areas, a stack current output during operation of the fuel cell stack to be set to a diagnostic current. The processor circuit is configured to determine, based on the stack operation information obtained by the one or more sensors and based on the controlling the stack current output to be set to the diagnostic current, a stack current and a stack voltage. The processor circuit is configured to diagnose, based on the stack current and the stack voltage entering the failure diagnosis area, failure associated with the fuel cell stack. The processor circuit is configured to control, based on the diagnosis of the failure, one or more operations associated with the fuel cell stack.

These and other features and advantages are described in greater detail below.

### BRIEF DESCRIPTION OF THE DRAWINGS

The above and other features of the present disclosure will now be described in detail with reference to certain examples thereof illustrated the accompanying drawings which are given by way of illustration only, and thus are not limitative of the present disclosure, and wherein:

FIG. 1 is a diagram illustrating stack performance curves and diagnostic areas in the present disclosure;

FIG. 2 is a block diagram illustrating the configuration of a fuel cell failure diagnosis system according to one example of the present disclosure; and

FIGS. 3A and 3B are flowcharts illustrating a fuel cell failure diagnosis process according to one example of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to examples of the present disclosure, examples of which are illustrated in the accompanying drawings and described below. Specific structural or functional descriptions set forth in the examples of the present disclosure will be merely exemplarily given to describe the examples depending on the concept of the present disclosure, and the examples depending on the concept of the present disclosure may be embodied in different forms. In addition, the present disclosure should not be construed as being limited to the examples set forth herein, and it will be understood that the present disclosure includes all modifications, equivalents, or substitutes included in the spirit and technical scope of the disclosure.

In the following description of the examples, terms, such as “first”, “second”, and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. The phrase “one or more of” is used interchangeably with “at least one of” herein.

When an element or layer is referred to as being “on”, “engaged with”, “connected to”, or “coupled to” another element or layer, it may be directly on, engaged with, connected to, or coupled to the other element or layer, or intervening elements or layers may be present. In contrast, when an element is referred to as being “directly on”, “directly engaged with”, “directly connected to”, or “directly coupled to” another element or layer, there may be no intervening elements or layers present. Other words used to describe the relationship between elements, e.g., “between” versus “directly between”, “adjacent” versus “directly adjacent”, etc., should be interpreted in a like fashion.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute as one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

Wherever possible, the same reference numbers will be used throughout the following description to refer to the same or like parts. The terminology used herein is for the purpose of describing particular examples only and is not intended to be limiting. As used herein, singular forms may be intended to include plural forms as well, unless the context clearly indicates otherwise. The terms “comprises”, “comprising”, “including”, and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Prior to describing the configuration of the present disclosure, in order to aid in understanding, the types of failures of fuel cell stacks will be described first as follows.

Causes of failures of fuel cell stacks include stack deterioration, insufficient supply of reactive gas, and poor hydrogen purity, and failures due to poor hydrogen purity include failure caused by inert gas inflow and failure caused by CO poisoning.

When/if deterioration of a fuel cell stack has occurred, a stack current may be high and a stack voltage may be lowered compared to a normal level. However, individual cell voltages may be in a normal state. In the following description, the stack voltage refers to an overall stack voltage, which is distinguished from the individual cell voltages.

If/when reactive gas supplied to a fuel cell stack (e.g., hydrogen or air supplied) is insufficient, a stack voltage may be normal but individual cell voltages may be lower than the normal level.

When/if failure due to poor hydrogen purity is caused by inflow of inert gas, a stack voltage may be normal but individual cell voltages may be lower than the normal level. Inert gas may include helium, nitrogen, or the like.

Further, if/when failure due to poor hydrogen purity is caused by CO poisoning of a fuel cell electrode catalyst, a stack voltage may be lowered compared to the normal level, but individual cell voltages may be in the normal state.

In the case of CO poisoning, the stack voltage may be much lower than a stack voltage in the case of stack deterioration when/if the stack current is in the low and/or medium current ranges. The probability of failure due to poor hydrogen purity caused by actual inflow of inert gas is very low. More than 95% of failures due to poor hydrogen purity are caused by CO poisoning.

A fuel cell failure diagnosis method according to one example of the present disclosure includes a method of diagnosing failure due to poor hydrogen purity. In order to diagnose failure due to poor hydrogen purity, stack operation information (e.g., information indicating the operating state of a fuel cell stack) may be monitored (e.g., in real time, near real time, periodically). Monitoring may be performed by one or more sensors measuring the operation information and/or one or more computing devices and/or processors that receive the stack operation information and/or measurements of stack operation. At least some of the stack operation information may be calculated based on measurements taken by sensors.

In an example of the present disclosure, the stack operation information may include one or more of a stack voltage, a stack current, individual cell voltages, and/or a cell voltage ratio (e.g., a value obtained by dividing a minimum cell voltage of the fuel cell stack by an average cell voltage). Another measure of cell voltage disparity/distribution/variation may be monitored (e.g., in addition to or instead of the cell voltage ratio). The above stack operation information may be used in various ways as control variables for various controls of a fuel cell system.

In the example of the present disclosure, the stack operation information may include variables that are monitored (e.g., in real time, near real time, periodically) to diagnose fuel cell failure. The variables may include real-time information that is detected (e.g., in real time, near real time, periodically, etc.) by sensing elements, such as sensors or sensing circuits, or obtained through estimation or calculation from detected information (from sensors and/or sensing circuits).

A method or process of detecting or obtaining the above variables (e.g., in real time, near real time, periodically, etc.) during operation of the fuel cell in a fuel cell vehicle, necessary hardware, etc. are technical matters known to those skilled in the art, and a detailed description thereof will thus be omitted.

In the present disclosure, the stack voltage and the cell voltage ratio are monitored (e.g., in real time, near real time, periodically, etc.) during fuel cell operation in order to diagnose failure due to poor hydrogen purity. A determination may be made as to whether the stack voltage and/or the individual cell voltages are high or low during fuel cell operation before hydrogen fueling.

If/when the stack voltage or the individual cell voltages are lower than a relevant normal level before hydrogen fueling (e.g., an average/threshold/specified stack voltage and/or an average/threshold/specified cell voltage, respectively), it may be determined that the stack performance is deteriorated. For example, the fuel cell stack may be diagnosed as being deteriorated or lacking hydrogen or air. Diagnosis of failure due to poor hydrogen purity may not be performed.

If/when the stack voltage or the individual cell voltage are at the normal level before hydrogen fueling, it may be determined that the stack performance before hydrogen fueling is normal, and normal stack performance state information may be stored in a memory.

After fueling the vehicle with hydrogen at a hydrogen fueling station, if/when it is determined that the stack performance is normal before hydrogen fueling but rapid deterioration of the stack performance occurs after hydrogen fueling, it may be primarily determined that this stack deterioration after fueling is due to influence of newly supplied hydrogen.

If/when the stack voltage or the individual cell voltages are lower than the normal level after hydrogen fueling, it may be determined that the stack performance is deteriorated. One or more emergency operations may be performed, such as an emergency purge operation for the stack and/or an increase in hydrogen supply pressure to the fuel cell stack.

A purge operation for the fuel cell stack may be performed by operating a purge device (e.g., a control circuitry configured to control operation of a purge valve) that performs hydrogen purge. For example, the purge device may repeatedly open and close the purge valve to perform the hydrogen purge. The emergency purge operation may be performed through control (hydrogen purge enhancement control, e.g., by the purge device) in which the number of hydrogen purges is increased to a set number compared to the case of normal purge.

If/when the stack voltage returns to the normal state (e.g., within normal levels) after the control for the emergency operation and/or purge operation is performed, and the stack performance is restored, this previous non-normal stack voltage and/or cell voltage may be diagnosed as failure due to poor hydrogen purity caused by inflow of impurities, such as inert gas.

If/when the stack performance is not restored even after completion of the emergency operation (e.g., if/when the stack performance, such as stack voltage and/or cell voltage continues to be abnormal, such as outside of normal levels), a determination may be made as to whether the stack performance is deteriorated and whether the stack fails caused by CO poisoning. The determination may be made using the stack current and the stack voltage among the stack operation information detected by the sensor during control of the stack current to be set to a predetermined diagnostic current.

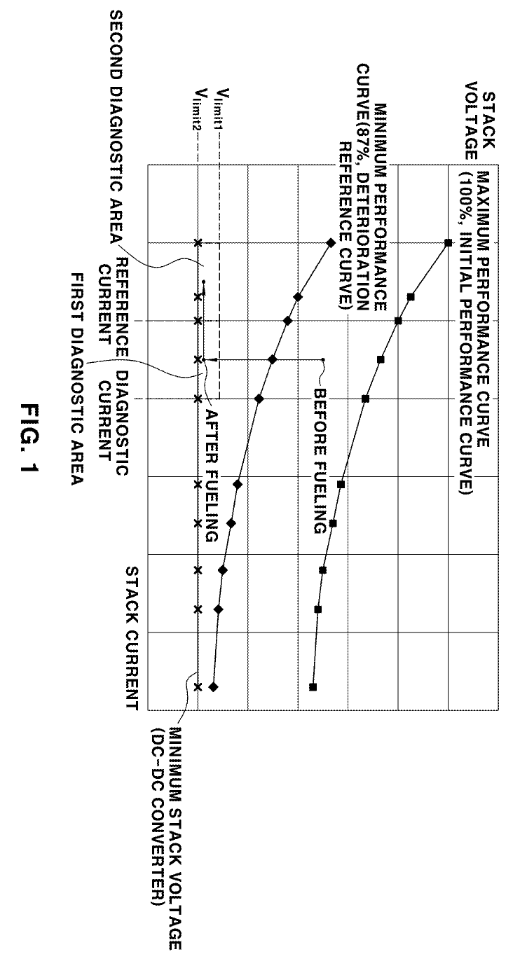

FIG. 1 is a diagram illustrating stack performance curves and diagnostic areas in the present disclosure. The stack performance curves are curves showing the relationship between the stack current and the stack voltage depending on the stack performance. The stack performance curves may be predetermined (measured by a manufacturer of the fuel cell stack, after installation of the fuel cell stack in a vehicle, etc.) and stored in a fuel cell failure diagnosis system to be used for failure diagnosis.

The stack performance curves include a maximum performance curve defining the relationship between the stack current and the stack voltage of the stack in a maximum performance state. For example, the maximum performance curve may correspond to performance of the stack immediately or soon after manufacture and/or at first use or near first user. The stack performance curves also include a minimum performance curve defining the relationship between the stack current and the stack voltage of the stack in a minimum performance state. For example, the minimum performance curve may be a curve corresponding to a minimum allowable/acceptable performance and/or may correspond to a threshold allowable/acceptable deterioration to the maximum performance curve as a reference curve.

A stack voltage range for which the stack performance is normal at each corresponding stack current may be defined based on the stack performance curves. An operating area between the maximum performance curve and the minimum performance curve may be an area where the stack performance is normal (i.e., a normal stack performance operating area). The stack voltage range where the stack performance is normal at each stack current may be defined by the normal stack performance operating area.

Referring to FIG. 1, a 100% performance curve, which is the maximum performance curve, and an 87% performance curve, which is the minimum performance curve, are shown as examples of the stack performance curves. An operating area between the two performance curves is the normal stack performance operating area. That is, for a given stack current, a range of voltages between two corresponding stack voltage values of the 100% performance curve and the 87% performance curve may be referred to as normal stack performance operating voltage.

In FIG. 1, the 100% performance curve may be referred to as a performance curve showing the relationship between the stack voltage and the stack current in stack state and conditions showing the maximum performance (e.g., an initial performance curve of the fuel cell stack).

In FIG. 1, the 87% performance curve (e.g., the curve representing the minimum performance) may be a performance curve showing the relationship between the stack voltage and the stack current in stack state and conditions representing 87% stack performance (e.g., 87% voltage for a given stack current) compared to 100% stack performance.

A specific stack current value may be predetermined as a reference current. A stack current area below the reference current and a stack current area above the reference current may be set as the diagnostic areas for fuel cell failure diagnosis.

A first diagnostic area may be the diagnostic area defined as the stack current area above the reference current. A second diagnostic area may be the diagnostic area defined as the stack current area below the reference current.

The first diagnostic area and the second diagnostic area are area, each of which has a predetermined current range and a predetermined voltage range, may be set as two current sections with the reference current as the boundary therebetween in the stack current. The first diagnostic area may be an area corresponding to a larger current value than the second diagnostic area.

Since the two diagnostic areas may be areas corresponding to two current ranges separated by the reference current as a boundary therebetween, each diagnostic area has an upper current limit and a lower current limit. The lower current limit of the first diagnostic area and the upper current limit of the second diagnostic area may be the reference current (e.g., a same reference current).

The first diagnostic area and the second diagnostic area may each be set to each have a set range of stack voltage. The voltage ranges of the two diagnostic areas may be set to have a same upper limit and lower limit. An upper voltage limit Vₗᵢₘᵢₜ₁ and a lower voltage limit Vₗᵢₘᵢₜ₂ may be constant values in the entire current section of the two diagnostic areas.

Therefore, in coordinates with the stack current as the horizontal axis and the stack voltage as the vertical axis, the first diagnostic area and the second diagnostic area may be represented as rectangular areas with the reference current as the boundary therebetween in the stack current and having the upper voltage limit Vₗᵢₘᵢₜ₁ and the lower voltage limit Vₗᵢₘᵢₜ₂ as constant values in the stack voltage, as shown in FIG. 1.

Here, the lower voltage limit Vₗᵢₘᵢₜ₂ of each diagnostic area may be a minimum stack voltage set based on the operating voltage of a balance of plant (BOP) system (e.g., an accessory device), and may be the minimum stack voltage at which the BOP system can operate.

The upper voltage limit Vₗᵢₘᵢₜ₁ of each diagnostic area may be set to a voltage value higher than the minimum stack voltage by a certain voltage value and/or percentage. For example, the upper voltage limit Vₗᵢₘᵢₜ₁ may be set as a value obtained by adding a constant voltage of 5 V to the minimum stack voltage Vₗᵢₘᵢₜ₂. Also, or alternatively, the upper voltage limit Vₗᵢₘᵢₜ₁ may be set as a value obtained by adding a constant percentage of 5% to the minimum stack voltage Vₗᵢₘᵢₜ₂.

Referring to FIG. 1, it may be confirmed that the lower voltage limit Vₗᵢₘᵢₜ₂ of the two diagnostic areas is set to the minimum stack voltage, and the upper voltage limit Vₗᵢₘᵢₜ₁ is set to a certain value in the entire current range. In the present disclosure, the second diagnostic area may be used as a CO poisoning diagnosis area for diagnosing CO poisoning.

In the example shown in FIG. 1, it may be confirmed that the reference current is 100 A, but this is an example and the present disclosure is not limited thereto. The reference current may be variously selected, set and/or changed depending on the specifications of the fuel cell stack and/or the configuration of the fuel cell system.

In the fuel cell system to which the present disclosure is applied, in the current area below the reference current (e.g., 0-100 A), the supply and cutoff of air may be repeated as the operation and stop of the fuel cell stack are repeated.

Accordingly, the current area below the reference current may be an area for which temporary stack performance deterioration may occur. In this area, it may be difficult to determine whether there is failure based on a stack operating point.

Therefore, the first diagnostic area, which is the current area above the reference current (e.g., an area greater than 100 A, such as including 120 A), may be set as a current area where diagnosis of failure due to stack deterioration or hydrogen or air shortage is effective. As such, stack operation may be controlled differently depending on differentiating between diagnosed causes of failure/deterioration.

Since the second diagnostic area is a current area where stack operation conditions may vary, such as the cell voltage ratio that may decrease depending on stack operation conditions, the second diagnostic area may not be an area where stack failure is diagnosed first.

However, in a secondary diagnostic process of determining whether CO impurities are introduced into hydrogen and/or whether CO poisoning occurs thereby, when/if the stack current decreases to the second diagnostic area during control of the fuel cell stack to output the diagnostic current, CO poisoning may be diagnosed.

Therefore, in the present disclosure, stack performance deterioration (e.g., a low stack voltage or cell voltage ratio) may be primarily diagnosed in the first diagnostic area (e.g., 100 A or more). is the first diagnostic area may be the stack failure diagnostic area. If/when stack performance deterioration is determined, the emergency purge operation may be performed. A determination may then be made as to whether stack performance is restored.

Stack performance deterioration caused by CO poisoning may be secondarily diagnosed using the second diagnostic area of 100 A or less. Even if the stack is deteriorated, it may not be possible to operate the stack in the second diagnostic area. Therefore, if/when the stack is operated in the second diagnostic area, CO poisoning may be diagnosed.

In one example of the present disclosure, failure that may be diagnosed through only the primary diagnosis may be failure due to stack deterioration and/or failure due to hydrogen or air shortage. Secondary diagnosis may be performed after the primary diagnosis to determine whether failure due to poor hydrogen purity occurred.

Since the initial performance of the fuel cell stack is 100%, the initial performance curve of the fuel cell stack is the maximum performance curve, which is the 100% performance curve. The stack voltage at each stack current indicated by the 100% performance curve may be the stack voltage of the initial performance (e.g., the stack voltage of the maximum performance).

When/if the performance (e.g., voltage at a given current) is lower than 87% of the initial performance, the fuel cell stack may be determined to be deteriorated. That is, the 87% performance curve, which is the minimum performance curve, may be a deterioration reference curve, and the stack voltage value at each stack current indicated by the 87% performance curve becomes a reference value that serves as a deterioration determination criterion.

In the following description, the above reference value (voltage on a minimum performance curve) is referred to as a “performance determination reference value”. When/if the stack voltage is lower than the “performance determination reference value”, the corresponding stack may be diagnosed as being in a performance deterioration state, such as degradation.

In one example of the present disclosure, the performance determination reference value may be a value that varies depending on the stack current. The performance determination reference value may be determined as a stack voltage value corresponding to the current stack current (current output from the current stack during the operation of the stack) on the minimum performance curve (e.g., the 87% performance curve), which may be stored as setting/configuration data.

In one example of the present disclosure, a case may be primarily (e.g., first) detected in which the stack is operated under a condition that the stack voltage in the first diagnostic area after hydrogen fueling is lower than a performance determination reference value (e.g. that is 87% of the voltage value of the 100% performance, i.e., the maximum performance) at the same stack current.

When/if the stack is detected to be operating under the condition that the stack voltage in the first diagnostic area after hydrogen fueling is lower than the performance determination reference value, the emergency purge operation may be performed. Thereafter, a process of diagnosing the cause of failure due to poor hydrogen purity (impurity inflow or CO poisoning) may be performed.

A current extraction command may be output (e.g., to the stack) to extract a required current from the stack. If CO is included as an impurity in hydrogen supplied to the vehicle and CO poisoning occurs after hydrogen fueling, for the required current, the stack voltage decreases and the stack may be operated in the lowest stack voltage area. It may be primarily (e.g., firstly) confirmed/determined whether the fuel cell stack is operated under the condition that the stack voltage is lower than the performance determination reference value when controlling the stack current that commands current extraction (i.e., a diagnostic current command which will be described below) in the first diagnostic area.

It may be confirmed/determined whether stack performance deterioration is caused by CO poisoning by monitoring the stack voltage in response to (e.g., given) the current extraction command in the first diagnostic area. It may be confirmed/determined whether the stack current decreases in the state of maintaining the current extraction.

It may be secondarily confirmed/determined whether the stack current gradually decreases due to the stack performance deterioration after/in response to the current extraction command and the operating state of the stack reaches the second diagnostic area, which is a stack operation area where no other failure is possible except for CO poisoning.

As such, in the present disclosure, it may be confirmed and/or determined (e.g., by a sequence of confirmations/determinations as disclosed herein) whether stack operation is performed in the area where no other failure is possible except for CO poisoning using the first diagnostic area and the second diagnostic area.

For example, a CO poisoning amount (e.g., level, severity, grade, etc.) may be determined. The CO poisoning amount may be determined based on a time during which the stack performance deteriorates during gradual decrease of the current extracted from the stack from the first diagnostic area to the second diagnostic area, and an accumulated current, and the determined CO poisoning amount information may be displayed through a display device to be provided to a driver of the corresponding vehicle.

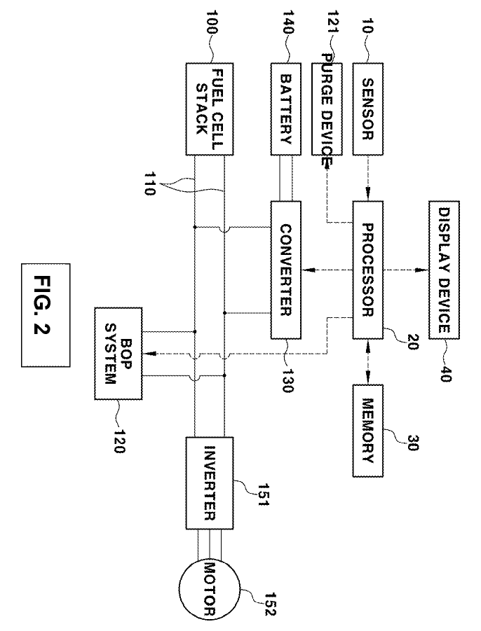

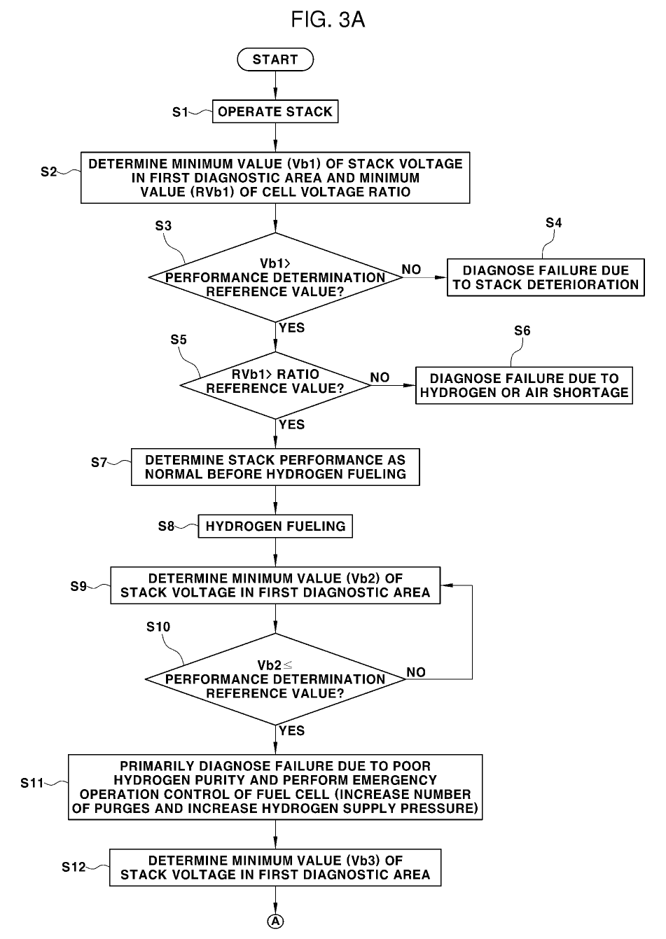

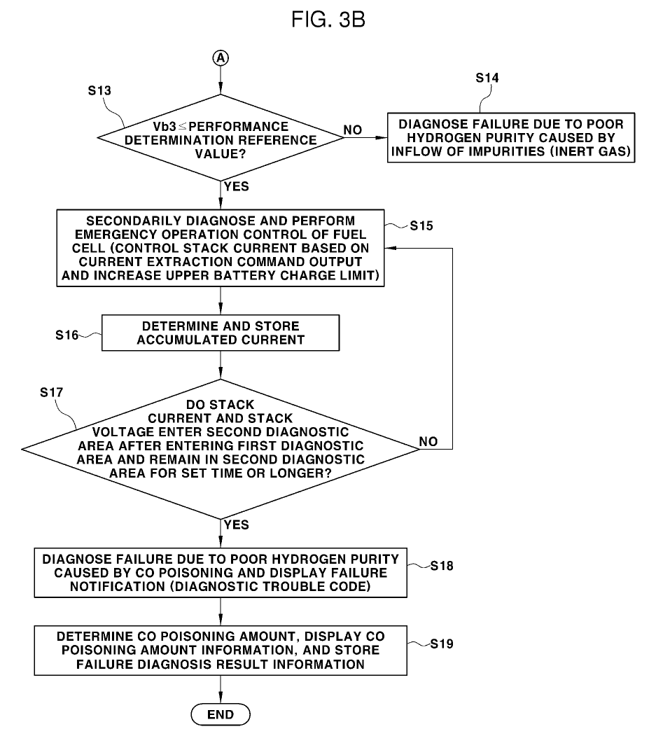

FIG. 2 is a block diagram showing the configuration of the fuel cell failure diagnosis system according to an example of the present disclosure, and FIGS. 3A and 3B are flowcharts showing a fuel cell failure diagnosis process according to one example of the present disclosure.

Referring to FIG. 2, a fuel cell system (e.g., mounted in a fuel cell vehicle) may include a fuel cell stack 100 that generates electrical energy via an electrochemical reaction of reaction gases, and a balance of plant (BOP) system 120, which may comprise a fuel cell driving device (e.g., fuel cell control circuitry), configured to drive/control the fuel cell system.

The fuel cell stack 100 and the BOP system 120 may be connected so as to be capable of supplying power by high-voltage main bus terminals (DC-DC link terminals) 110. The BOP system 120 may include, for example, an air supply device, a hydrogen supply device, and/or a heat and/or water management device.

The BOP system 120 may include power-consuming components for driving the fuel cell system, such as an air compressor and/or an air blower of the air supply device, a hydrogen recirculation blower of the hydrogen supply device, and/or a water pump of the heat and/or water management device.

The fuel cell vehicle may be equipped with a battery 140, which may be an auxiliary power source that stores electrical energy generated from the fuel cell stack 100. The fuel cell stack 100 may be a main power source, and the battery 140 may be connected to the main bus terminals 110 via a converter 130 (e.g., a DC-DC converter, a direct current converter.

The converter 130 may convert electrical power generated by the fuel cell stack 100 into power that may be used to charge the battery 140. The converter 130 may supply the power to the battery 140, so that the battery 140 may be charged with the supplied power.

The fuel cell stack 100 and the battery 140 may be connected (e.g., via the main bus terminals 110) to a motor 152 for driving the vehicle. The motor 152 may be connected to the main bus terminals 110 via an inverter 151 so as to be capable of receiving power from the fuel cell stack 100 and the battery 140 as operating power.

The battery 140 may be connected to the motor 152 through the converter 130, the main bus terminals 110, and the inverter 151 so as to be capable of being charged and discharged. The converter 130 may be a bidirectional high-voltage DC-DC converter (BHDC) that is disposed between the battery 140 and the main bus terminals 110 to perform bidirectional power conversion.

The inverter 151 may serve to drive and/or control the motor 152. The inverter 151 may convert direct current (DC) applied from the fuel cell stack 100 or the battery 140 via the main bus terminals 110 into a three-phase alternating current (AC) and apply the alternating current (AC) to the motor 152.

The inverter 151 may convert the AC power (e.g., regenerative power) generated by the motor 152 into direct current. The inverter 151 may apply the direct current to the main bus terminals 110 when/if the vehicle performs regenerative braking. The converter 130 may convert the regenerative power applied to the main bus terminals 110 into power that may charge the battery 140. The battery 140 may be charged with the converted power supplied to the battery 140.

The fuel cell failure diagnosis system according to one example of the present disclosure includes sensors 10 that detect and/or obtain stack operation information, a processor 20 (e.g., processor circuit) that processes signals received from the sensors 10 and performs control for failure diagnosis, a memory 30 that stores an algorithm and data, where the memory 30 may be driven by the processor 20, and the converter 130, operation of which may be controlled depending on a control signal output from the processor 20.

The sensors 10 may serve to detect, measure, and/or obtain information indicating the operating state of the fuel cell stack 100, referred to herein as the stack operation information. The sensors 10 may include one or more cell voltage sensors that detect the voltages of a plurality of cells forming the fuel cell stack 100. The sensors 10 may include a current sensor that detects a stack current, and a stack voltage sensor (or a sensing circuit and/or a sensing device) that detects a stack voltage. The sensors 10 may also include, for example, one or more of temperature sensors, pressure sensors, level sensors, flow sensors, additional electrical circuit sensors, and/or proximity sensors. The additional electrical circuit sensors may comprise, for example one or more impedance sensors (e.g., an electrical resistance sensor). The electrical circuit sensors (e.g., voltage sensor(s)) may measure a voltage deviation and/or or a voltage difference between/across cells (e.g., a difference between an average cell voltage and a minimum cell voltage of the fuel cell stack).

The sensors 10 may be electrically connected to the processor 20 that performs control for fuel cell failure diagnosis. Sensor signals (e.g., electrical signals output from the sensors 10) may be input to/received by the processor 20.

The processor 20 may be provided to control the overall operation of the fuel cell system in response to a driver's requested output, and/or to perform control for failure diagnosis. The processor 20 may receive the sensor signals and monitor the stack operation information, which may comprise and/or be based on sensor detection information in the sensor signals, (e.g., in real time, near real time, periodically, etc.).

The stack operation information may include, for example, the stack voltage detected by the stack voltage sensor, the stack current detected by the current sensor (a current output from the stack during the operation of the stack), the individual cell voltages detected by the cell voltage sensors, and/or a cell voltage ratio (and/or other indicator of cell voltage deviation).

The cell voltage ratio is defined as a value obtained by dividing the minimum cell voltage of the fuel cell stack 100 by the average cell voltage. The processor 20 may determine the cell voltage ratio from the individual cell voltages detected by the cell voltage sensors.

In an example of the present disclosure, the processor 20 may be a fuel cell control unit (FCU) that may comprise control circuitry that controls the overall operation of the fuel cell system, and/or may be a separate controller (control circuitry, control circuit, etc.) that is connected to the fuel cell control unit as an upper-level controller so as to be communicable with the fuel cell control unit. A controller (e.g., control circuitry/control circuit/control device) may include a communication device communicating with other controllers or one or more sensors (e.g., sensors disclosed herein) to control one or more functions and/or operations in charge (e.g., control operations of the fuel cell stack), a memory storing an operation system, a logic command, and input/output information, and/or one or more processors performing determination, calculation, and decision necessary for controlling the one or more functions and/or operations in charge. A controller may include, for example, a processor, a central processing unit (CPU), a microchip, a logic, an application-specific integrated circuit (ASIC), memory, etc. A controller may manipulate and/or control other components in the system (e.g., a fuel cell stack, fuel cell system, a fuel cell vehicle, etc.).

In an example of the present disclosure, the memory 30 may be implemented as a storage medium that stores at least one command and/or instructions and various setting data for operating the processor 20.

The memory 30 may store sensor detection information obtained by/via the sensors 10, and/or may store various setting data required for fuel cell failure diagnosis, and various information generated, collected and/or obtained during performance of the fuel cell failure diagnosis process.

The setting data may include diagnostic area data and stack performance data for fuel cell failure diagnosis. The stack performance data may include the minimum performance curve, for example.

Various examples described herein may be implemented as software including one or more commands/instruction stored in a storage medium (e.g., internal memory and/or external memory) that may be read by machines (e.g., computing devices or processors) (i.e., a computer-readable storage medium). For example, the processor 20 may call at least one command/instruction among the one or more stored commands/instructions from the memory 30 implemented as the storage medium, and execute the called command/instruction. The at least one command/instruction may include code generated by a compiler or code that may be executed by an interpreter. The storage medium that may be read by the processor 20 may be provided in the form of a non-transitory storage medium. Here, “non-transitory” means that the storage medium is a tangible device and does not include a signal (e.g., electromagnetic wave) per se. “Non-transitory” herein does not distinguish between a case where data is stored permanently/semi-permanently in the storage medium and a case where data is temporarily stored in the storage medium.

The processor 20 may include hardware (e.g., a semiconductor device, a controller/control circuitry, or the like) for implementing various examples described herein. The processor 20 may include one or more cores, and may include a central processing unit (CPU) of a computing device, a general purpose graphics processing unit (GPGPU), a tensor processing unit (TPU), an application processor (AP), an application specific integrated circuit (ASIC), or a processor for data analysis and deep learning, such as a field programmable gate array (FPGA). The processor for deep learning may be controlled to process input data according to predefined operation rules or artificial intelligence models stored in a memory. If one or more processors are artificial intelligence dedicated processors, the artificial intelligence dedicated processor may be designed with a hardware structure specialized for processing a specific artificial intelligence model.

The memory 30 may be a memory capable of storing various information and setting data, such as maps, required to implement various examples described herein. The memory 30 may include at least one-type of storage medium among a flash memory type, a hard disk type, a multimedia card micro type, a card type memory (for example, an SD or XD memory, etc.), a random access memory (RAM), a static random access memory (SRAM), a dynamic random access memory (DRAM), a magnetic random access memory (MRAM), a read-only memory (ROM), an electrically erasable programmable read-only memory (EEPROM), a programmable read-only memory (PROM), a magnetic memory, a magnetic disk, and an optical disc. In addition, the memory 30 may include any type of computer-readable recording medium well known in the technical field related to the present disclosure. In addition, as an example, the storage medium or the recording medium may include a medium managed by an app store that distributes applications, or a site, server, or the like that supplies or distributes various software. The description of the above-mentioned memory 30 is only an example, and the present disclosure is not limited thereto.

The converter 130 may be disposed between the fuel cell stack 100 and the battery 140 and between the main bus terminals 110 and the battery 140. The converter 130 may control the outputs of the fuel cell stack 100 and the battery 140 depending on a control signal (e.g., a current extraction command) output from the processor 20.

Particularly, the processor 20 may control the operation of the converter 130 based on a driver’s requested output (requested current) to control the current (stack current) output from the fuel cell stack 100.

The voltage of the main bus terminals 110 may be varied by the converter 130 connected to the main bus terminals 110. When/if the processor 20 outputs a current extraction command (e.g., a control signal) to output a diagnostic current, the operation of the converter 130 is controlled depending on the current extraction command, so that a main bus terminal voltage and a stack voltage are controlled, and thus a stack current may be controlled.

The fuel cell failure diagnosis system according to an example of the present disclosure may include a purge device 121 that performs purge of the fuel cell stack 100. The purge device 121 may be a purge valve for hydrogen purge, and/or may be provided to perform an emergency purge operation depending on a control signal output from the processor 20 (e.g., during/in response to the failure diagnosis process).

The fuel cell failure diagnosis system according to the example of the present disclosure may further include a display device 40 controlled by the processor 20 to display failure diagnosis result information. The display device 40 may be a cluster of the vehicle or an AVN display device. Another display device 40 is just an example, and another interface may be used to output failure diagnosis result information (and/or receive user input discussed herein. The interface may be a device through which a user can interact with a device. The interface may include an input interface (also referred to as an input device) that can receive an input from the (e.g., human) user and/or an output interface (also referred to as an output device) through which data or information can be output to the (e.g., human) user. An input interface may include, for example, a button, a knob, a toggle, a switch, a dial, a slider, a keyboard, a touchscreen, a control panel, an instrumentation panel, a center console (also referred to as a central console), a microphone, a stalk (e.g., a control stalk), a gear shift control (e.g., a gear stick, a gear stalk, etc.), a camera, a wheel, a steering wheel, a pedal, a lever, etc. An output interface may include, for example, a light (e.g., an indicator light), a lamp, an indicator, a screen, a display (e.g., display device 40), a console, a dashboard, a meter, a gauge, a speaker, etc. Any of the input interfaces described herein may also be an output interface, and vice versa. For example, a center console may be considered both an input interface (e.g., equipped with buttons, knobs, sliders, a touchscreen, etc.) and an output interface (e.g., equipped with a display, indicator lights, etc.). The display device 40 will be discussed in the example herein.

The operation of the display device 40 may be controlled by the processor 20. The processor 20 may control the operation of the display device 40 to display the diagnosis result information including/indicating CO poisoning amount information and a diagnostic trouble code (DTC) of the fuel cell stack 100 obtained by the failure diagnosis process.

The fuel cell failure diagnosis process performed by the above-described fuel cell failure diagnosis system (also referred to as a fuel cell management system and/or fuel cell management apparatus) will be described in detail with reference to FIGS. 3A and 3B. A control subject of the fuel cell failure diagnosis process, which will be described below, may be the processor 20.

For convenience, FIGS. 3A-3B are described by way of an example in which the steps are performed by a processor circuit. One, some, or all steps of the example method(s) of FIGS. 3A-3B, or portions thereof, may be performed by one or more other circuits (e.g., processor 20). One or more steps of the example method(s) of FIGS. 3A-3B may be omitted, performed in other orders, and/or otherwise modified, and/or one or more additional steps may be added.

In order to diagnose fuel cell failure, the fuel cell system may be operated before hydrogen fueling (S1), and the processor 20 may control the stack current within the first diagnostic area during the power generation operation of the fuel cell stack 100 before hydrogen fueling.

The processor 20 may monitor the stack voltage and the cell voltage ratio during control of the current stack current (current output from the current stack during the operation of the stack) within the first diagnostic area. The stack voltage and the cell voltage ratio may be based on the stack operation information collected via the sensors 10 during the operation of the fuel cell stack 100. The processor may determine a minimum value Vb1 of the stack voltage and a minimum value RVb1 of the cell voltage ratio (S2).

The processor 20 may compare the minimum value Vb1 of the stack current in the first diagnostic area with a performance determination reference value (e.g., the stack voltage of the 87% performance curve) (S3) compare the minimum value RVb1 of the cell voltage ratio in the first diagnostic area with a predetermined ratio reference value (e.g., 0.7) (S5).

The performance determination reference value may be a stack voltage value in the stack performance data (on the 87% performance curve) corresponding to the stack current detected by the sensor 10 when determining the minimum value Vb1 of the stack voltage.

Based on the above comparison, when/if the minimum value Vb1 of the stack voltage in the first diagnostic area is greater than the performance determination reference value (S3 - Yes), a determination may be made as to whether the minimum value RVb1 of the cell voltage ratio is greater than the ratio reference value (S5). If the minimum value RVb1 of the cell voltage ratio is greater than the ratio reference value (S5 - Yes), the processor 20 may determine that the stack performance before hydrogen fueling is normal (S7).

When/if the minimum value Vb1 of the stack voltage in the first diagnostic area is lower than or equal to the performance determination reference value (S3 - No), the processor 20 may diagnose failure due to stack deterioration (S4). The processor 20 may diagnose failure due to hydrogen or air shortage When/if the minimum value RVb1 cell voltage ratio is lower than or equal to the ratio reference value (S5 - No), the processor 20 may diagnose failure due to hydrogen or air shortage (S6).

The performance determination reference value that is compared with the minimum value Vb1 of the stack voltage may be determined from the setting data input and stored in the memory 30. for example, the performance determination reference value may be based on the above-described minimum performance curve (e.g., 87% performance curve) data, and a stack voltage value corresponding to the same stack current value (stack current when the stack voltage is the minimum value). The performance determination reference value corresponding to the monitored stack current may be obtained from the minimum performance curve (e.g., 87% performance curve) and used as the performance determination reference value.

When/if the stack performance is normal, the processor 20 continues to monitor the stack voltage and the cell voltage ratio before hydrogen fueling based on the stack operation information collected during the operation of the fuel cell stack 100 (S7).

Hydrogen fueling may be performed (S8). The processor 20 may, after the fueling, control the stack current within the first diagnostic area during the operation of the fuel cell stack 100. The processor may determine a minimum value Vb2 of the stack voltage during the control of the stack current within the first diagnostic area (S9).

The processor 20 may compare the minimum value Vb2 of the stack voltage in the first diagnostic area with the performance determination reference value (S10). The performance determination reference value that is compared with the minimum value Vb2 of the stack voltage may be determined from the minimum performance curve (e.g., 87% performance curve).

When/if stack performance deterioration, in which the minimum value Vb2 of the stack voltage in the first diagnostic area is lower than or equal to the performance determination reference value, is detected through the comparison (S10 - Yes), the processor 20 may primarily diagnose that performance deterioration due to poor hydrogen purity occurs (S11). When/if stack performance deterioration is not detected through the comparison (S10 - No), the minimum value Vb2 of the stack voltage in the first diagnostic area may be determined (return to S9).

In order to identify the cause of poor hydrogen purity, the processor 20 may perform the emergency operation control of the fuel cell stack 100 for a set operation time (e.g., 30 seconds) (S11). The emergency operation control may include increasing (raising) the number of hydrogen purges and/or a hydrogen supply pressure for the fuel cell stack 100 to a set number of times and a set pressure, respectively (e.g., increasing compared to normal operation/non-emergency purge operation). In this way, hydrogen purge enhancement control may be performed for the emergency operation.

After completing the emergency operation control for the set operation time, the processor 20 may restore the operating state of the fuel cell stack 100 to the normal state. The processor 20 may control the stack current within the first diagnostic area during the (e.g., normal) operation of the fuel cell stack 100. the processor 20 may determine a minimum value Vb3 of the stack voltage during the control of the stack current within the first diagnostic area (S12).

The processor 20 may compare the minimum value Vb3 of the stack voltage in the first diagnostic area with the performance determination reference value determined from the minimum performance curve (e.g., 87% performance curve) (S13).

If/when the minimum value Vb3 of the stack voltage is greater than the performance determination reference value (S13 - No), the processor 20 may determine that the stack performance has been recovered through the hydrogen purge enhancement control. If/when the stack performance has been recovered through emergency operation control (e.g., including the hydrogen purge enhancement control) herein, the stack performance deterioration may be determined as due to inflow of impurities, such as inert gas, present in the supplied hydrogen into the fuel cell stack 100, and thus, the failure due to poor hydrogen purity may be diagnosed as being caused by inflow of impurities, such as inert gas, (S14).

If/when the minimum value Vb3 of the stack voltage is lower than or equal to the performance determination reference value (S13 - Yes), it may be determined that the stack performance has not been recovered. The processor 20 may perform a process of secondarily diagnosing whether the failure due to poor hydrogen purity is caused by CO poisoning (S15).

The secondary diagnosis may be performed to determine whether the failure is caused by CO poisoning (CO is included as an impurity in the supplied hydrogen) in the fuel cell emergency operation control state.

If CO poisoning is diagnosed based only on whether the minimum value Vb3 of the stack voltage is lower than or equal to the performance determination reference value, there may be a risk of misdiagnosis. Therefore, the secondary diagnosis process may be performed to prevent such misdiagnosis.

When/if CO poisoning occurs in the fuel cell stack 100, the function of an anode catalyst may be deteriorated. Even if a hydrogen concentration is recovered by hydrogen purge, there may be no/reduced/incomplete improvement in the stack performance. Rather, when/if new hydrogen and CO are continuously supplied, CO poisoning may be accelerated.

If/when the stack performance is not recovered even after the hydrogen purge enhancement control, the secondary diagnosis process and the fuel cell emergency operation control for secondary diagnosis are performed to diagnose whether the failure is caused by CO poisoning. In the secondary diagnosis process, stack current control may be performed to detect a specific phenomenon in which the stack 100 is operated at the lower voltage limit Vₗᵢₘᵢₜ₂ of the diagnostic areas when CO poisoning continues.

In the emergency operation control of the fuel cell stack 100 for secondary diagnosis of failure due to poor hydrogen purity, the processor 20 may output a current extraction command (e.g., a current control signal) to control the stack current to be set to a predetermined diagnostic current (e.g., 150 A).

The diagnostic current may be set to a current value within the current range of the first diagnostic area. The diagnostic current may be set to a maximum current value within the current range of the first diagnostic area. For example, when/if the current range of the first diagnostic area is set to 100A to 150 A, a current value of 150 A may be used as the diagnostic current.

At the same time, the processor 20 may increase (raise) an upper battery charge limit to a set value compared to an upper battery charge limit for the normal operation. Increasing the upper battery charge limit may result in charging the battery 140 with a surplus current generated by the current extraction command, considering that the stack current is increased more than a required current (i.e., a higher stack current than the required is generated) by outputting the current extraction command to control the stack current to be set to the diagnostic current.

A battery state of charge (SOC) may be increased, and a battery output after charging may be additionally determined/used. Increasing the upper battery charge limit may allow for preemptively preparing for (using the battery output) an inability to respond to a driver's requested output due to stack performance deterioration. Increasing the upper battery charge limit may increase the driving range of the vehicle.

When/if the current extraction command to control the stack current to be set to the diagnostic current having a constant current value is output from the processor 20, the output of the fuel cell stack 100 may be controlled by the converter 130 (e.g., according to the current extraction command).

If/when the current extraction command is output as the diagnostic current, the processor 20 may determine an accumulated current by accumulating (e.g., integrating a monitored/tracked/measured value of) the current extracted from the stack 100 during decrease of the current to a set current within the second diagnostic area from a point in time when the stack voltage reaches the lower voltage limit Vₗᵢₘᵢₜ₂. The determined accumulated current may be stored in the memory 30 (S16). The current extracted from the stack 100 may be a current detected by the sensor 10 (e.g., in real time, periodically, etc.).

In one example of the present disclosure, the set current may be set to a minimum current value within the current range of the second diagnostic area. For example, if/when the current range of the second diagnostic area is set to 50 A to 100 A, a current value of 50 A may be set as the set current.

The accumulated current may be an accumulated current required until the stack performance is deteriorated by CO poisoning. That is, the accumulated current may be an accumulated current required until the stack performance is deteriorated so that the stack current and stack voltage, which are stack operation information, enter the second diagnostic area from the first diagnostic area and the stack current decreases to the set current in the state in which the stack voltage is at the lower voltage limit. The accumulated current may be referred to as/correspond to an accumulated hydrogen consumption.

If/when CO poisoning has occurred, the stack voltage may drop to the lower voltage limit Vₗᵢₘᵢₜ₂ of the first diagnostic area. If/when CO poisoning has occurred, even if the output of the current extraction command to control the stack current to be set to the diagnostic current is sent/maintained, the stack current may gradually decrease over time. The stack current decreases to a current value of the second diagnostic area from the first diagnostic area.

If/when the stack current and stack voltage (maintaining the lower voltage limit) enters the second diagnostic area and then remain in the second diagnostic area for a set time or longer (S17 - Yes)while the diagnostic current extraction command is maintained (e.g., sent/being executed), the processor 20 may diagnose failure due to poor hydrogen purity caused by CO poisoning (S18).

In a situation other than CO poisoning, stack operation in the second diagnostic area may be impossible. If/when the stack current and the stack voltage, indicating the operating state of the fuel cell stack 100, enter the second diagnostic area, failure caused by CO poisoning may be diagnosed.

As such, if/when it is determined that the stack current and the stack voltage primarily enter the first diagnostic area and then secondarily enter the second diagnostic area, it may be determined that there is failure caused by CO poisoning.

In the CO poisoning situation, the stack voltage may reach the lower voltage limit Vₗᵢₘᵢₜ₂ of the first diagnostic area and the second diagnostic area, and the lower voltage limit Vₗᵢₘᵢₜ₂ in the diagnostic areas may be the minimum voltage at which the stack 100 may be operated in the fuel cell system.

During stack operation, the stack voltage may not be lowered to a voltage lower than the lower voltage limit Vₗᵢₘᵢₜ₂. In the CO poisoning situation, the stack may be fixedly operated at the lower voltage limit Vₗᵢₘᵢₜ₂, and the stack current continuously decreases over time.

When/if failure caused by CO poisoning is diagnosed, the processor 20 may control the operation of the display device 40 to inform the driver of a failure condition, and at this time, the processor 20 may control the display device 40 to display a diagnostic trouble code (DTC) indicating the failure condition caused by CO poisoning (S19). The processor 20 may control the display device 40 to display a driving range determined based on current battery SOC information.

In addition, in one example of the present disclosure, the accumulated current may be defined as a CO poisoning amount, and the processor 20 may determine the accumulated current and then determine the accumulated current as the CO poisoning amount (S19). When the CO poisoning amount is determined, CO poisoning amount information may be stored in the memory 30 together with the diagnostic trouble code, and failure diagnosis result information, such as the CO poisoning amount and the diagnostic trouble code, may be displayed through the display device 40 to be provided to the driver (S19).

The present disclosure has been made in an effort to solve problems associated with technical field to which it pertains. The present disclosure to provide a fuel cell failure diagnosis/management system and method capable of accurately detecting and diagnosing CO poisoning of a fuel cell, for example, caused by unintentional fueling with hydrogen with poor purity. The disclosed system and method may provide faster and more accurate maintenance guidelines.

The present disclosure is not limited to the above-mentioned aspects/features, and other aspects/features not mentioned herein will be clearly understood by persons having ordinary knowledge in the technical field to which the present disclosure pertain (“those skilled in the art”) from the present description.

The present disclosure provides a fuel cell failure diagnosis system including sensors configured to obtain stack operation information configured to indicate an operating state of a fuel cell stack, a memory configured to store data on diagnostic areas for fuel cell failure diagnosis, and a processor configured to perform control for fuel cell failure diagnosis using the stored diagnostic area data based on the obtained stack operation information, wherein the diagnostic areas include a carbon monoxide poisoning diagnosis area set to diagnose carbon monoxide poisoning of a fuel cell electrode catalyst, and the processor diagnoses failure due to carbon monoxide poisoning, based on determining that, among the obtained stack operation information, a stack current and a stack voltage decrease and enter the carbon monoxide poisoning diagnosis area, during control of the stack current output during operation of the fuel cell stack to be set a predetermined diagnostic current.

The diagnostic areas may include a first diagnostic area configured to have a set current range and a set voltage range, and a second diagnostic area provided as the carbon monoxide poisoning diagnosis area and set to have a lower current range than the first diagnostic area.

The processor may determine whether stack performance is normal before hydrogen fueling based on the stack operation information obtained during control of the stack current output during the operation of the fuel cell stack to be set to a current within the first diagnostic area before hydrogen fueling, and perform control to diagnose the failure due to carbon monoxide poisoning after hydrogen fueling, based on determining that the stack performance is normal before hydrogen fueling.

The processor may determine a minimum stack voltage value and a cell voltage ratio from the stack operation information during the control of the stack current to be set to the current within the first diagnostic area, and determine whether the stack performance is normal before hydrogen fueling based on the minimum stack voltage value and the cell voltage ratio.

The processor may determine whether the stack performance is normal after hydrogen fueling based on the stack operation information obtained during the control of the stack current output during the operation of the fuel cell stack to be set to the current within the first diagnostic area after hydrogen fueling, perform control for emergency operation including an emergency purge operation for the fuel cell stack, based on determining that the stack performance is abnormal after hydrogen fueling, determine whether the stack performance is normal before hydrogen fueling based on the stack operation information obtained during the control of the stack current output during the operation of the fuel cell stack to be set to the current within the first diagnostic area, after completion of the emergency operation, and perform the control to diagnose the failure due to carbon monoxide poisoning, based on determining that the stack performance is abnormal after the completion of the emergency operation.

The processor may determine a minimum stack voltage value from the stack operation information during the control of the stack current to be set to the current within the first diagnostic area after hydrogen fueling, and determine that the stack performance is abnormal after hydrogen fueling, based on determining that the determined minimum stack voltage value is lower than or equal to a performance determination reference value, and the performance determination reference value may be set to a value corresponding to the stack current among the stack operation information obtained based on determining the minimum stack voltage value after hydrogen fueling.

The control for the emergency operation may include control for the emergency purge operation configured to increase the number of hydrogen purges for the fuel cell stack compared to normal operation, and control configured to increase a hydrogen supply pressure for the fuel cell stack compared to the normal operation.

The processor may diagnose failure due to poor hydrogen purity caused by inflow of inert gas into supplied hydrogen.

The processor may accumulate the stack current until, among the stack operation information, the stack current and stack voltage enter the second diagnostic area via the first diagnostic area, and determine a carbon monoxide poisoning amount from the accumulated current, during the control of the stack current output during operation of the fuel cell stack to be set to the diagnostic current.

The diagnostic current may be set to a current value within the first diagnostic area, and the processor may accumulate the stack current until, among the stack operation information, the stack current decreases to a set current within the second diagnostic area from a point in time at which, among the stack operation information, the stack voltage decreases to a lower voltage limit within the first diagnostic area, and determine the carbon monoxide poisoning amount from the accumulated current, during the control of the stack current to be set to the diagnostic current.

During the control of the stack current output during the operation of the fuel cell stack to be set to the predetermined diagnostic current, the processor may increase an upper battery charge limit to a set value higher than an upper battery charge limit during normal operation.

The processor may diagnose the failure due to carbon monoxide poisoning, based on determining that, among the obtained stack operation information, the stack current and the stack voltage decrease, enter the carbon monoxide poisoning diagnosis area, and then remain in the carbon monoxide poisoning diagnosis area for a set time or longer.

The present disclosure provides a fuel cell failure diagnosis method including obtaining, by a processor, stack operation information configured to indicate an operating state of a fuel cell stack from sensor signals, controlling, by the processor, a stack current output during operation of the fuel cell stack to be set to a predetermined diagnostic current, determining, by the processor, whether, among the obtained stack operation information, the stack current and a stack voltage decrease and enter a carbon monoxide poisoning diagnosis area set to diagnose carbon monoxide poisoning of a fuel cell electrode catalyst out of diagnostic areas, during the control of the output stack current to be set to the diagnostic current, and diagnosing, by the processor, failure due to carbon monoxide poisoning, based on determining that the obtained stack current and stack voltage enter the carbon monoxide poisoning diagnosis area.

According to the fuel cell failure diagnosis system and method of the present disclosure, it is possible to diagnose and distinguish between failure due to poor hydrogen purity in which a fuel cell vehicle is fueled with hydrogen with poor purity due to impurities and failure due to poor hydrogen purity caused by CO poisoning of a fuel cell electrode catalyst. That is, the causes of failures due to poor hydrogen purity may be divided into impurity inflow and CO poisoning.

Therefore, appropriate fail-safe performance and maintenance may be enabled/performed depending on the cause of the failure. Excessive expenses due to stack replacement or incorrect maintenance caused by misdiagnosis may be prevented.

In addition, an air bleeding time and stack recovery power vary depending on the CO poisoning amount in the fuel cell stack, and according to the present disclosure, since it is possible to determine the CO poisoning amount based on the stack performance deterioration trend, accurate maintenance guidelines may be provided.

In addition, a situation in which the vehicle is not capable of being operated due to a rapid decrease in stack performance may be prevented through preemptive battery SoC charging operation when failure is detected, and the safety of vehicle operation may be secured based on battery output.

As is apparent from the above description, according to the fuel cell failure diagnosis system and method according to the present disclosure, it is possible to diagnose failure due to poor hydrogen purity in which a fuel cell vehicle is fueled with hydrogen with poor purity due to impurities and failure due to poor hydrogen purity caused by CO poisoning of a fuel cell electrode catalyst, distinguishably. That is, the causes of failures due to poor hydrogen purity may be divided into impurity inflow and CO poisoning.

Therefore, appropriate fail-safe performance and maintenance may be enabled depending on the cause of the failure, and excessive expenses due to stack replacement or incorrect maintenance caused by misdiagnosis may be prevented.

In addition, an air bleeding time and stack recovery power vary depending on a CO poisoning amount in a fuel cell stack, and according to the present disclosure, since it is possible to determine the CO poisoning amount based on the stack performance deterioration trend, accurate maintenance guidelines may be provided.

In addition, a situation in which a vehicle is not capable of being operated due to a rapid decrease in stack performance may be prevented through preemptive battery SoC charging operation when failure is detected, and the safety of vehicle operation may be secured based on battery output.

Although the examples of the present disclosure have been described in detail above, the scope of the present disclosure is not limited thereto, and various modifications and improvements made by those skilled in the art using the basic concept of the present disclosure defined in the following claims are also included in the scope of the present disclosure.

What is claimed is:

1. A fuel cell system comprising:
one or more sensors configured to obtain stack operation information indicating an operating state of a fuel cell stack;
a memory configured to store data indicating one or more diagnostic areas for fuel cell failure diagnosis, wherein the one or more diagnostic areas comprise a carbon monoxide poisoning diagnosis area associated with carbon monoxide poisoning of a fuel cell electrode catalyst; and
a processor circuit configured to:
control, based on the stored data indicating the one or more diagnostic areas, a stack current output during operation of the fuel cell stack to be set to a diagnostic current;
determine, based on the stack operation information obtained by the one or more sensors and based on the controlling the stack current output to be set to the diagnostic current, a stack current and a stack voltage;
diagnose, based on the stack current and the stack voltage entering the carbon monoxide poisoning diagnosis area, failure associated with carbon monoxide poisoning of the fuel cell stack; and
control, based on the diagnosis of the failure, one or more operations associated with the fuel cell stack.

2. The fuel cell system of claim 1, wherein the one or more diagnostic areas comprise:
a first diagnostic area defined by a set current range and a set voltage range, and the carbon monoxide poisoning diagnosis area that is set to have a lower current range than the set current range of the first diagnostic area , and
wherein the stored data indicating the one or more diagnostic areas comprises stack current values of the fuel cell stack and stack voltage values of the fuel cell stack.

3. The fuel cell system of claim 2, wherein the processor circuit is configured to:
determine, based on stack operation information obtained while operation of the fuel cell stack is set to use a current within the first diagnostic area before hydrogen fueling, whether stack performance of the fuel cell stack is normal before the hydrogen fueling; and
control the stack current to be set to the diagnostic current further based on determining that the stack performance is normal before the hydrogen fueling.

4. The fuel cell system of claim 3, wherein the processor circuit is configured to:
determine, based on stack operation information obtained while operation of the fuel cell stack is set to use the current within the first diagnostic area, a minimum stack voltage value and a cell voltage ratio; and
determine whether the stack performance is normal before the hydrogen fueling based on the minimum stack voltage value and the cell voltage ratio.

5. The fuel cell system of claim 3, wherein the processor circuit is configured to:
determine, based on the stack operation information obtained while operation of the fuel cell stack is set to use the current within the first diagnostic area after the hydrogen fueling, whether the stack performance is normal after the hydrogen fueling;
control, based on determining that the stack performance is abnormal after the hydrogen fueling, an emergency operation comprising an emergency purge operation for the fuel cell stack;
determine, based on stack operation information obtained while operation of the fuel cell stack is set to use the current within the first diagnostic area and after the emergency purge operation, whether the stack performance is normal before the hydrogen fueling; and
control, based on the stack performance being determined as abnormal after the emergency operation, a diagnosis operation to diagnose a failure due to carbon monoxide poisoning of the fuel cell stack.

6. The fuel cell system of claim 2, wherein the processor circuit is configured to:
determine, based on stack operation information obtained while operation of the fuel cell stack is set to use a current within the first diagnostic area after hydrogen fueling, a minimum stack voltage value; and
determine, based on the minimum stack voltage value being lower than or equal to a performance determination reference value, that stack performance of the fuel cell stack is abnormal after the hydrogen fueling,
wherein the performance determination reference value is set to a value corresponding to the stack current from stack operation information obtained based on determining the minimum stack voltage value after the hydrogen fueling.

7. The fuel cell system of claim 5, wherein the emergency purge operation comprises an increased number of hydrogen purges for the fuel cell stack relative to a number of hydrogen purges during normal operation of the fuel cell stack; and
wherein the processor circuit is further configured to control, during the emergency operation, an increase in a hydrogen supply pressure for the fuel cell stack relative to a hydrogen supply pressure during normal operation of the fuel cell stack.

8. The fuel cell system of claim 6, wherein the processor circuit is configured to diagnose failure due to poor hydrogen purity caused by inflow of inert gas into supplied hydrogen.

9. The fuel cell system of claim 2, wherein the processor circuit is configured to:
accumulate the stack current until stack operation information indicates the stack current and stack voltage enter the carbon monoxide poisoning diagnosis area from the first diagnostic area, and
determine, based on the accumulated stack current and during control of the stack current to be set to the diagnostic current, a carbon monoxide poisoning amount.

10. The fuel cell system of claim 9, wherein:
the diagnostic current is set to a current value within the first diagnostic area; and
the processor circuit is configured to accumulate the stack current until the stack operation information indicates that, after the stack voltage decreases to a lower voltage limit within the first diagnostic area, the stack current decreases to a set current within the carbon monoxide poisoning diagnosis area.

11. The fuel cell system of claim 1, wherein the processor circuit is configured to, during control of the stack current output during the operation of the fuel cell stack to be set to use the diagnostic current, increase an upper battery charge limit to a set value higher than a value of the upper battery charge limit during normal operation of the fuel cell stack.

12. The fuel cell system of claim 1, wherein the processor circuit is configured to diagnose the failure occurred due to carbon monoxide poisoning based on the stack current and the stack voltage decrease remaining in the carbon monoxide poisoning diagnosis area for a set time or longer.

13. A method comprising:
receiving, by a processor associated with a fuel cell system from one or more sensors associated with the fuel cell system, stack operation information indicating an operating state of a fuel cell stack of the fuel cell system;
controlling, by the processor, a stack current output during operation of the fuel cell stack to be set to a diagnostic current;
determining, by the processor based on the stack operation information and based on the controlling the stack current output to be set to the diagnostic current, a stack current and a stack voltage; and
diagnosing, by the processor and based on the stack current and the stack voltage entering a carbon monoxide poisoning diagnosis area defined by stack current values and stack voltage values associated with carbon monoxide poisoning of a fuel cell electrode catalyst, failure of the fuel cell stack due to carbon monoxide poisoning; and
controlling, based on the diagnosis of the failure, one or more operations associated with the fuel cell stack.

14. The method of claim 13, wherein the carbon monoxide poisoning diagnosis area is one of a plurality of diagnostic areas, and
wherein the plurality of diagnostic areas comprise:
a first diagnostic area defined by a set current range and a set voltage range, and
the carbon monoxide poisoning diagnosis area that is set to have a lower current range than the set current range of the first diagnostic area.

15. The method of claim 14, further comprising:
determining, based on stack operation information obtained while operation of the fuel cell stack is set to use a current within the first diagnostic area before hydrogen fueling, whether stack performance of the fuel cell stack is normal before the hydrogen fueling; and
controlling the stack current to be set to the diagnostic current further based on determining that the stack performance is normal before the hydrogen fueling.

16. The method of claim 15, further comprising:
determining, based on stack operation information obtained while operation of the fuel cell stack is set to use the current within the first diagnostic area after the hydrogen fueling, whether the stack performance is normal after the hydrogen fueling;
controlling, based on determining that the stack performance is abnormal after the hydrogen fueling, for emergency operation comprising an emergency purge operation for the fuel cell stack;
determining, based on stack operation information obtained while operation of the fuel cell stack is set to a current within the first diagnostic area and after the emergency purge operation, whether the stack performance is normal before the hydrogen fueling; and
controlling, based on the stack performance being determined as abnormal after the emergency purge operation, a diagnosis operation to diagnose a failure associated with carbon monoxide poisoning of the fuel cell stack.

17. The method of claim 16, wherein the emergency purge operation comprises an increased number of hydrogen purges for the fuel cell stack relative to a number of hydrogen purges during normal operation of the fuel cell stack; and
wherein the method further comprises:
controlling, during the emergency operation, an increase in a hydrogen supply pressure for the fuel cell stack relative to a hydrogen supply pressure during normal operation of the fuel cell stack.

18. The method of claim 14, further comprising:
accumulating the stack current until stack operation information indicates that the stack current and stack voltage enter the carbon monoxide poisoning area via the first diagnostic area, and
determining, based on the accumulated stack current and during controlling of the stack current to be set to the diagnostic current, a carbon monoxide poisoning amount.

19. The method of claim 13, further comprising, during controlling of the stack current to be set to use the diagnostic current, increasing an upper battery charge limit to a value higher than a value of the upper battery charge limit during normal operation of the fuel cell stack.

20. A vehicle comprising:
a fuel cell stack configured to supply power to the vehicle;
one or more sensors configured to obtain stack operation information indicating an operating state of the fuel cell stack;
a memory configured to store data indicating one or more diagnostic areas for fuel cell failure diagnosis, wherein the one or more diagnostic areas comprise a failure diagnosis area associated with a fuel cell electrode catalyst; and
a processor circuit configured to:
control, based on the stored data indicating the one or more diagnostic areas, a stack current output during operation of the fuel cell stack to be set to a diagnostic current;
determine, based on the stack operation information obtained by the one or more sensors and based on the controlling the stack current output to be set to the diagnostic current, a stack current and a stack voltage;
diagnose, based on the stack current and the stack voltage entering the failure diagnosis area, failure associated with the fuel cell stack; and
control, based on the diagnosis of the failure, one or more operations associated with the fuel cell stack.
